(19) United States
(12) Patent Application Publication
(10) Pub. No.: US 2015/0330335 A1
(43) Pub. Date: Nov. 19, 2015

(54) EXHAUST DEVICE FOR INTERNAL COMBUSTION ENGINE

(71) Applicant: DENSO CORPORATION, Kariya-city (JP)

(72) Inventors: Hiroki SHIMADA, Anjo-city (JP); Kazushi SASAKI, Obu-city (JP); Satoshi ISHIGAKI, Takahama-city (JP)

(21) Appl. No.: 14/676,033

(22) Filed: Apr. 1, 2015

(30) Foreign Application Priority Data
May 16, 2014 (JP) 2014-101981

(51) Int. Cl. F02M 25/07; F02D 41/22; F02D 41/00

(52) U.S. Cl. CPC F02M 25/0756; F02D 41/0077; F02D 41/22; F02M 25/0702; F02M 25/079; F02M 25/0773

(57) ABSTRACT

In an exhaust device for an internal combustion engine, a control device controls a motor based on an output signal of a sensor. The control device has a first valve position detector detecting a first valve position when a valve unit is biased to close using only a biasing force of a spring. The control device has a second valve position detector detecting a second valve position when the valve unit is biased to close using a driving force of the motor that is larger than the biasing force of the spring. The control device detects a foreign object between a valve object and a valve seat and detects a size of the foreign object based on a comparison result between the first valve position and the second valve position.

### CROSS REFERENCE TO RELATED APPLICATION

This application is based on Japanese Patent Application No. 2014-101981 filed on May 16, 2014, the disclosure of which is incorporated herein by reference in its entirety.

### TECHNICAL FIELD

The present disclosure relates to an exhaust device for an internal combustion engine.

### BACKGROUND

Conventionally, an internal combustion engine is equipped with an exhaust gas recirculation (EGR) system that recirculates a part of emission gas (exhaust gas) discharged from the engine cylinder to the intake passage as EGR gas. The EGR gas is mixed with fresh air drawn through an air cleaner so as to lower the combustion temperature, such that NOx generation is restricted.

When the EGR gas is refluxed to the intake passage, the combustion stability within the engine cylinder may fall and the engine output power may be reduced. It is necessary to control the flow rate of EGR gas introduced into the engine cylinder according to the engine operation situation.

In the EGR system, an EGR control valve is disposed in the EGR passage, which connects the exhaust passage to the intake passage, to control the flow rate of EGR gas. The EGR control valve has a poppet valve, and the opening of the poppet valve is controlled to control the flow rate of EGR gas introduced into the engine cylinder.

EGR cut is conducted, for example, when the engine load is low and when the engine has relatively low-speed rotation, in order to stabilize the combustion state, by stopping the introduction of EGR gas to fresh air. EGR is performed also when a driver presses down the accelerator pedal to obtain the maximum engine output, in order to avoid the fall in the engine output that is caused by introducing EGR gas into the combustion chamber.

JP 2013-256885A and JP 2014-043852A (US 2014/0034029A1) describe EGR control valve which variably controls the flow rate of EGR gas flowing through the EGR passage.

The EGR control valve has an electric actuator, an output shaft, a plate cam, followers, pins, an EGR valve, a return spring and a valve seat. The electric actuator has an electric motor and a deceleration mechanism. The output shaft is connected to be integrally rotatable with an output gear of the deceleration mechanism as an output shaft of the deceleration mechanism. The plate cam is connected to be integrally rotatable with the output shaft. The followers are inserted in the cam groove of the plate cam. The pins rotatably support the followers. The poppet-type EGR valve has the valve shaft connected to be integrally movable with the pins. The return spring biases the EGR valve in the valve-closing direction relative to the output shaft. The valve object (valve head, valve body) of the EGR valve is able to be seated on the annular valve seat.

When the EGR control valve is fully closed to conduct the EGR cut, the valve body is completely contact with the valve seat, and a clearance between the valve body and the valve seat is tightly sealed, such that the leak flow of EGR gas becomes zero.

The EGR control valve is equipped with a rotation angle sensor which outputs a sensor output value (voltage) corresponding to the rotation angle of the output shaft to an electrical control unit (ECU).

However, if a foreign matter (e.g., solid such as metal or synthetic resin, or adhesive elastic object such as deposit) is located between the valve body and the valve seat, the valve body is in contact with the foreign matter. In this case, the sealing will become imperfect, and a gap is generated between the valve body and the valve seat. If the leak flow of EGR gas increases in case where the EGR control valve is fully closed, the engine output and the exhaust emission deteriorate.

### SUMMARY

It is an object of the present disclosure to provide an exhaust device for an internal combustion engine, which can control increase in leak flow of exhaust gas when a valve is fully closed.

According to an aspect of the present disclosure, an exhaust device for an internal combustion engine includes: a valve seat in which a passage is defined to pass through from a cylinder of the internal combustion engine; and a valve unit having a valve object seated on or separated from the valve seat to open or close the passage, and a valve shaft that supports the valve object. The valve shaft extends in an axial direction, and the valve unit is able to move in the axial direction. A motor generates a driving force to drive the valve unit, and a rotation shaft is rotated in response to the driving force of the motor. A conversion mechanism converts a rotational movement of the rotation shaft to a linear movement of the valve unit. An actuator drives the valve object to open or close by transmitting the driving force of the motor to the valve unit through the rotation shaft and the conversion mechanism. A spring generates a biasing force to bias the valve unit to close the passage. A sensor outputs a signal corresponding to a current position of the valve unit. A control device controls the motor based on an output signal of the sensor. A first valve position detector detects a first valve position from the output signal of the sensor when the valve unit is biased to close using only the biasing force of the spring to press the valve object against the valve seat. A second valve position detector detects a second valve position from the output signal of the sensor when the valve unit is biased to close using the driving force of the motor that is larger than the biasing force of the spring by supplying electricity to the motor to press the valve object against the valve seat.

A foreign object detector detects a foreign object between the valve object and the valve seat by comparing the first valve position and the second valve position with each other and detects a size of the foreign object based on a comparison result between the first valve position and the second valve position. In case where the foreign object is located between the valve object and the valve seat, the foreign object may be deformed and removed by the foreign object remover of the control device.

Accordingly, the clearance between the valve object and the valve seat can be made small. Therefore, the valve object can be set at a totally close position (where the valve object is seated on the valve seat) when the valve is fully closed, such that increase in the leak flow of exhaust gas can be controlled.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a schematic view illustrating a poppet valve according to a first embodiment in an operation state;

FIG. 2 is a schematic view illustrating the poppet valve of the first embodiment in another operation state;

FIG. 3 is a sectional view illustrating an EGR control valve of the first embodiment; FIG. 4 is a cross-sectional view taken along a line IV-IV of FIG. 3;

FIG. 5 is a perspective view illustrating an electric actuator and the poppet valve of the first embodiment;

FIG. 6 is a perspective view illustrating the electric actuator and the poppet valve of the first embodiment;

FIG. 7 is a block diagram illustrating sensors, ECU, and a motor of the first embodiment;

FIG. 8 is a flow chart illustrating a detection of a foreign object by the ECU of the first embodiment;

FIG. 9 is a flow chart illustrating a deforming and removing of a foreign object by the ECU of the first embodiment;

FIG. 10 is a flow chart illustrating another deforming and removing of a foreign object by the ECU of the first embodiment;

FIG. 11 is a sectional view illustrating an EGR control valve according to a second embodiment; and

FIG. 12 is a plan view illustrating an actuator of the second embodiment without a sensor cover.

### DETAILED DESCRIPTION

Embodiments of the present disclosure will be described hereafter referring to drawings. In the embodiments, a part that corresponds to a matter described in a preceding embodiment may be assigned with the same reference numeral, and redundant explanation for the part may be omitted. When only a part of a configuration is described in an embodiment, another preceding embodiment may be applied to the other parts of the configuration. The parts may be combined even if it is not explicitly described that the parts can be combined. The embodiments may be partially combined even if it is not explicitly described that the embodiments can be combined, provided there is no harm in the combination.

### First Embodiment

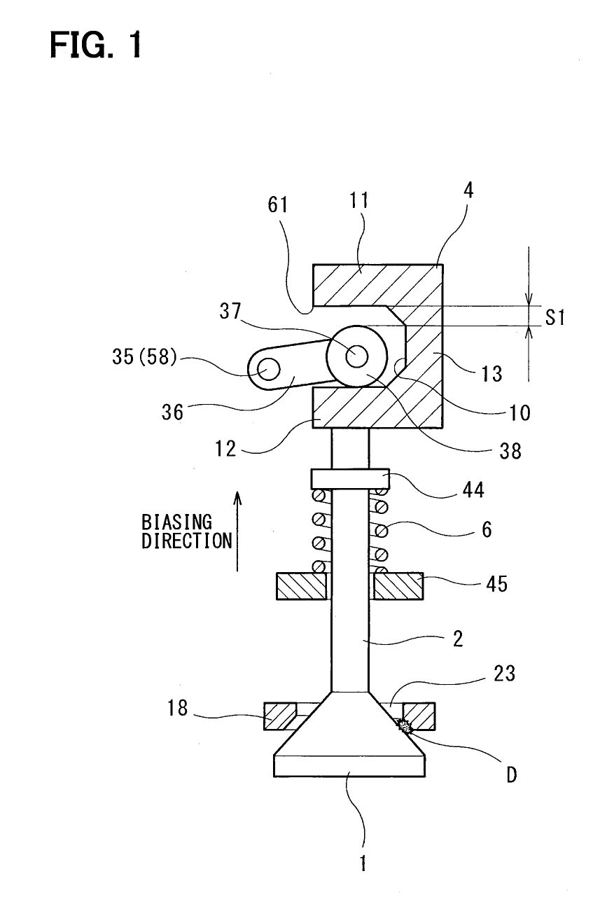

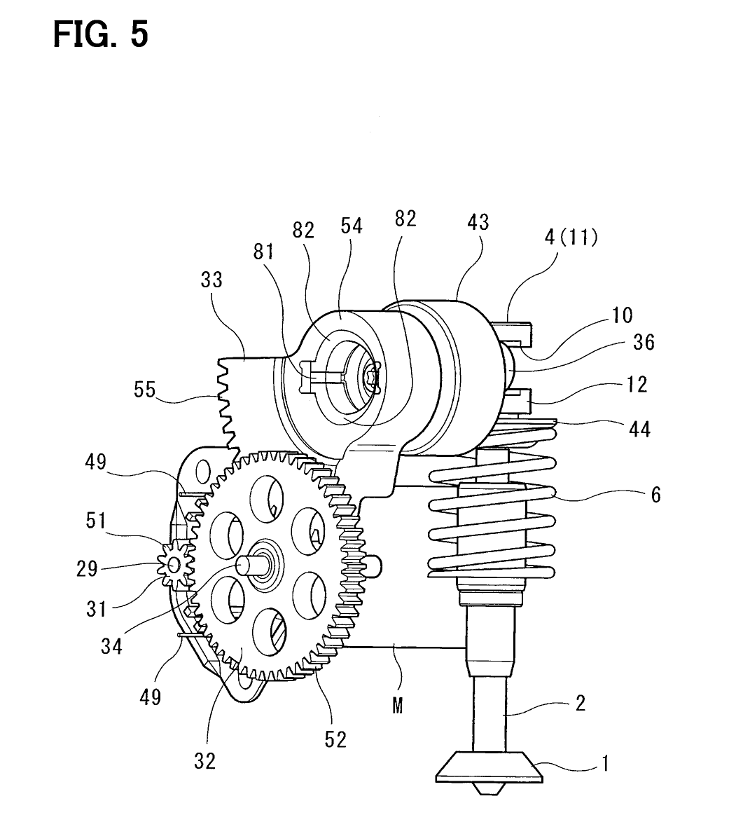

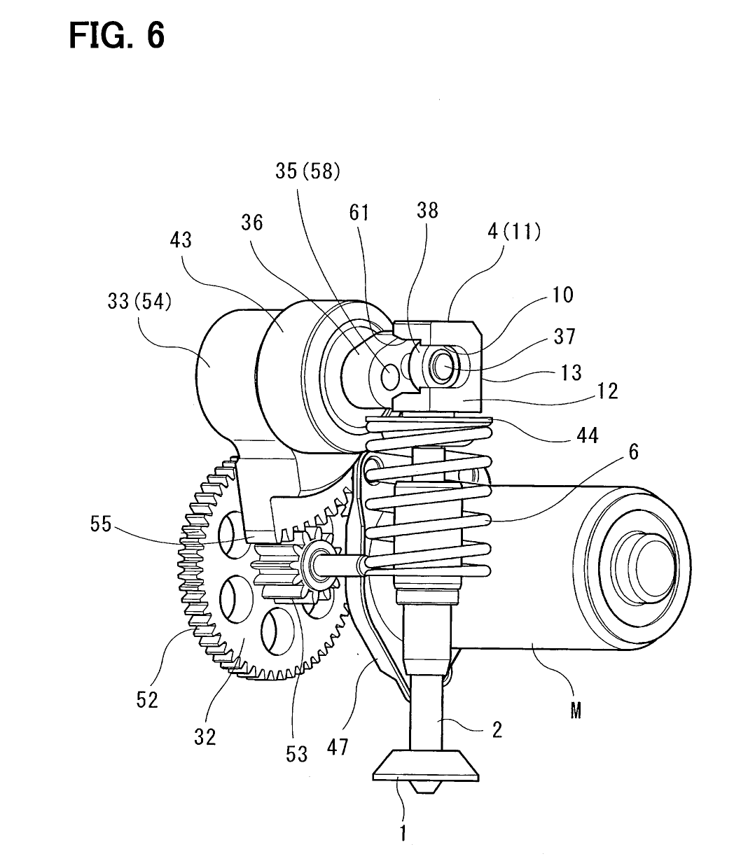

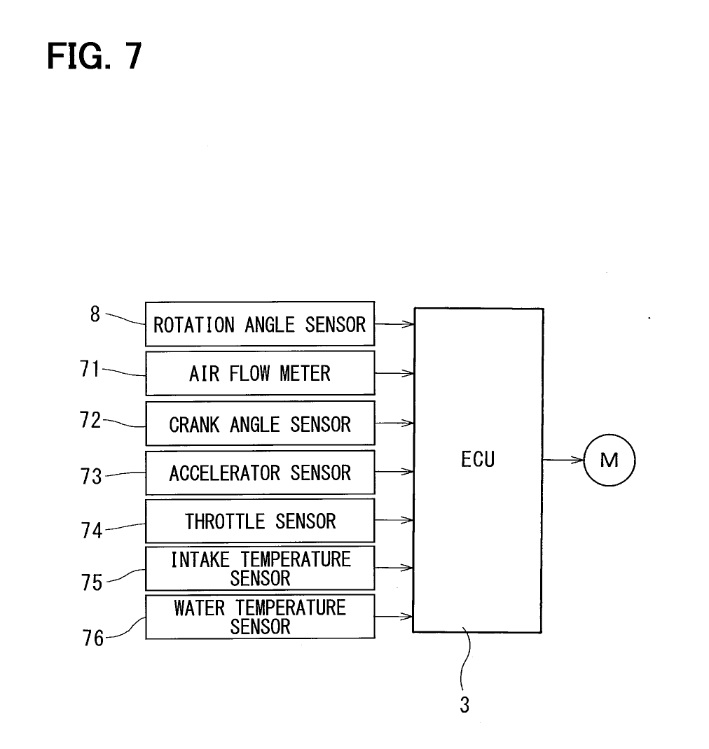

An exhaust gas recirculation (EGR) control valve for an EGR system is described with reference to FIG. 1 to FIG. 10.

An exhaust device (exhaust system) of an internal combustion engine includes the EGR system which recirculates a part of gas exhausted from the engine into the intake passage as EGR gas for a vehicle.

The EGR system is equipped with an EGR pipe which refluxes EGR gas from the exhaust passage in an exhaust manifold or an exhaust pipe to the intake passage in an intake manifold or an intake pipe. An EGR passage is defined in the EGR pipe, and EGR gas is made to flow into the intake passage from the exhaust passage through the EGR passage.

The EGR passage corresponds to a passage into which exhaust gas discharged from the cylinder of the engine flows. The EGR passage is a fluid passage communicated to the combustion chamber of the engine, and fluid containing the exhaust gas flows in the fluid passage.

The EGR control valve is disposed in the EGR pipe to variably control the flow rate of EGR gas flowing through the EGR passage. The EGR system is used as a control device for controlling the EGR control valve to open and close a poppet valve of the EGR control valve based on an engine operation condition. The control device has an engine control unit (exhaust control device, motor control device, electronic control unit: ECU) 3 to control an electric motor (direct-current motor) M in connection with other system such as intake system or boost pressure control system. The motor M is a part of an electric actuator which drives a valve shaft 2 to reciprocate in an axial direction. The poppet valve has a valve object 1 (valve body, valve member, valve head) in addition to the valve shaft 2 (valve stem).

The EGR control valve has the poppet valve, the electric actuator and a housing 7. The poppet valve controls the flow rate of EGR gas flowing through the EGR passage. The electric actuator drives the valve shaft 2 of the poppet valve to reciprocate in the axial direction. The housing 7 receives the poppet valve, the electric actuator, a Scotch yoke 4 having U-shaped (rectangle) cross-section, and a return spring 6. A recess portion that holds the electric actuator is defined between the housing 7 and a sensor cover 9 to which a rotation angle sensor 8 is mounted as an EGR opening sensor.

The poppet valve has the valve object 1 and the valve shaft 2. The valve object 1 has a circular shape and opens and closes the EGR passage in the housing 7 to control the open area. The valve shaft 2 supports and fixes the valve object 1. The valve shaft 2 has an input unit at the base end part in the axial direction. Rotation power (torque, driving force) of the motor M is input into the input unit of the valve shaft 2 from the electric actuator through the Scotch yoke 4. The valve object 1, the valve shaft 2, the Scotch yoke 4, and the return spring 6 are assembled beforehand, and are attached to the housing 7 in the subassembly state.

The Scotch yoke 4 is press-fittingly connected and fixed to the perimeter (top end) of the input unit of the valve shaft 2 and is able to move integrally with the valve shaft 2. Alternatively, the Scotch yoke 4 is connected by using a connector or joint produced by, for example, a laser welding in a manner that the Scotch yoke 4 is able to move integrally with the valve shaft 2.

The Scotch yoke 4 has a first arm 11, a second arm 12, and an arm connector 13. The arm connector 13 connects the base end part of the first arm 11 and the base end part of the second arm 12 to each other. The first arm 11 and the second arm 12 are arranged to oppose each other through a predetermined space (yoke slot 10).

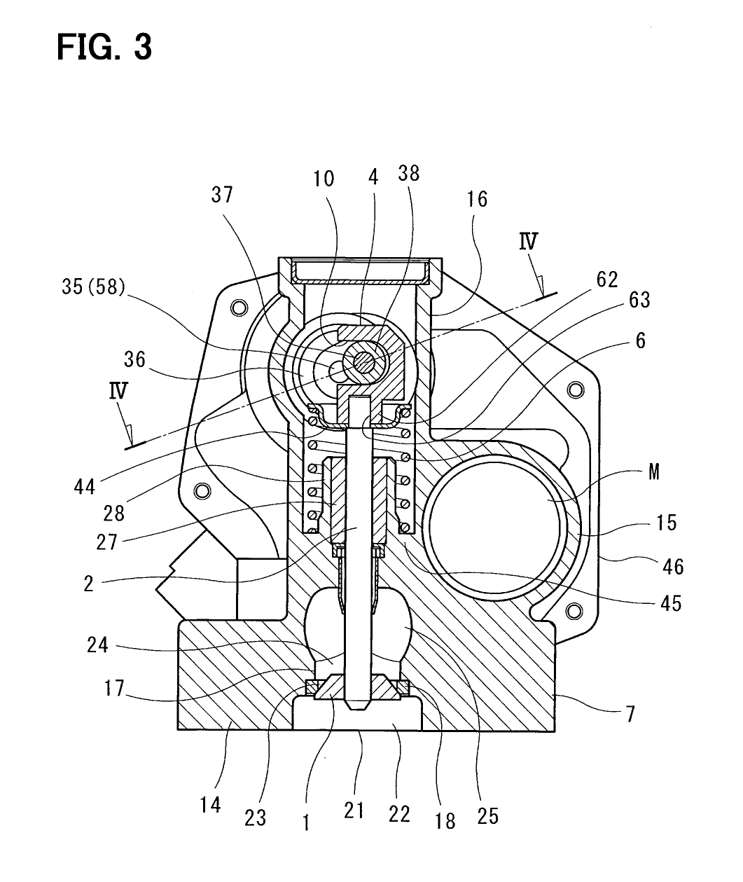

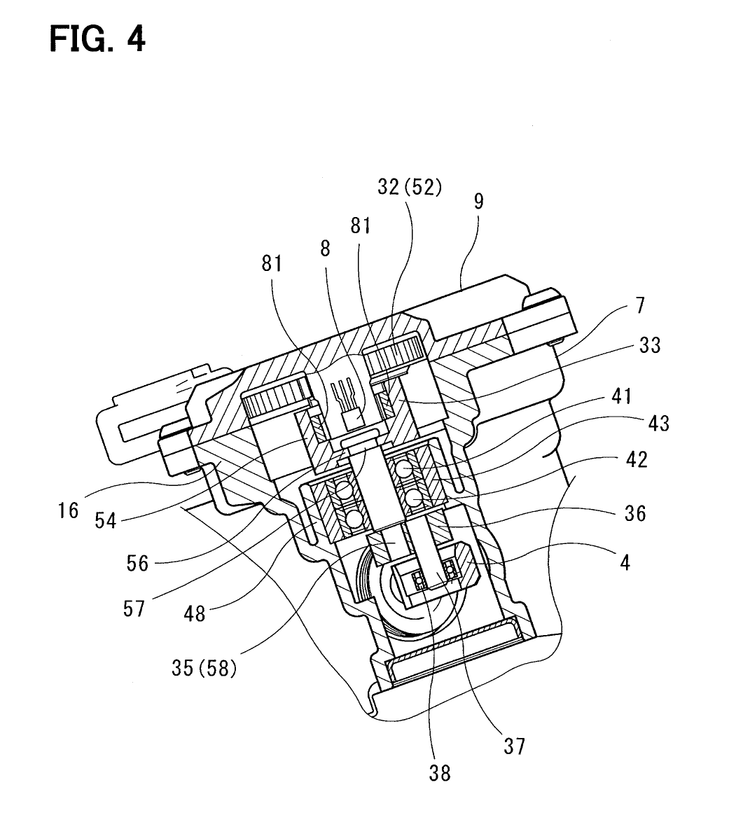

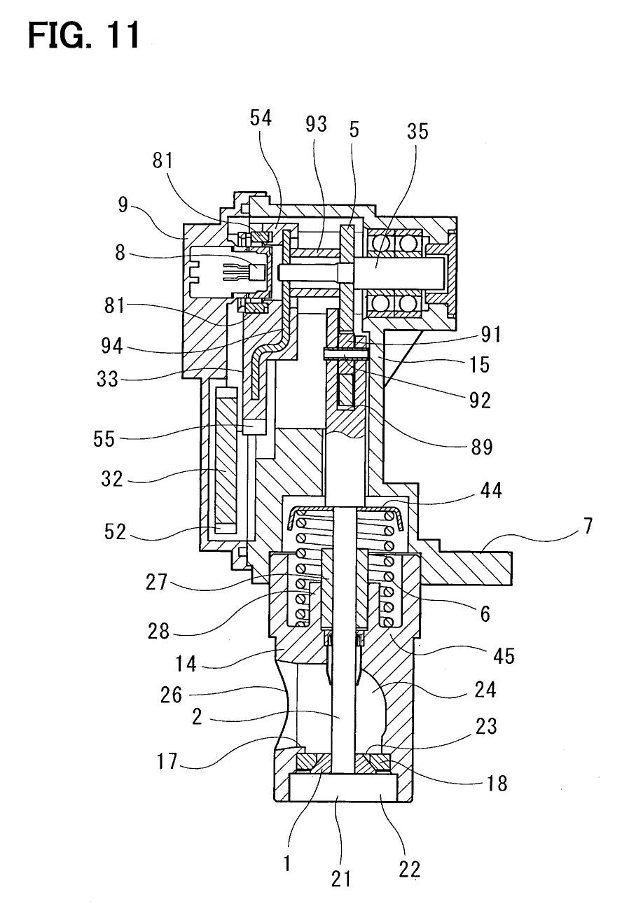

The housing 7 integrally has a valve object 14, a motor case 15 and a gear case 16. The poppet valve is arranged in the valve object 14. The motor M is arranged in the motor case 15. A gear train (deceleration mechanism) is arranged in the gear case 16. A valve seat 18 is press-fittingly fixed to the inner circumference of the partition wall 17 of the valve object 14. The valve seat 18 has a circular shape, and the valve object 1 can be seated on the valve seat 18. The valve object 1 of the poppet valve is a valve head which is separated from or seated on the valve seat 18 of the housing 7 to open or close the EGR passage, in the order of the inlet port 21, the passage holes 22-25, and the outlet port 26 (see FIG. 3 and FIG. 11).

The valve shaft 2 is a valve stem that reciprocates in the axial direction of the poppet valve in response to a rotational displacement of the output component (33, 35-38, 41-43 to be mentioned later). The input unit of the valve shaft 2 receives a driving force of the electric actuator (motor M) from the Scotch yoke 4, at the base end part of the valve shaft 2 in the axial direction.

The valve shaft 2 has the output unit which outputs the driving force of the electric actuator (motor M) to the valve object 1 of the poppet valve, at the tip end part of the valve shaft 2 in the axial direction. The axial middle part of the valve shaft 2 is slidably supported by the bearing holder 28 of the housing 7 through the metal bearing 27.

The electric actuator has the motor M, the deceleration mechanism, a conversion mechanism, the output component, and a rotation angle sensing device. The motor M has a motor shaft 29 as a rotation axis. The deceleration mechanism slows down the rotation of the motor shaft 29 of the motor M by two steps. The conversion mechanism (linkage mechanism) connects the deceleration mechanism and the Scotch yoke 4 to each other. The output component is constructed to include a part of the deceleration mechanism and the conversion mechanism, and outputs the driving force of the motor M to the yoke side. The rotation angle sensing device detects the rotation angle of the output component.

The motor M has an inner rotor, a stator, and brushes (first brush and second brush). The inner rotor (armature) has a motor shaft 29 extending in the axial direction. The cylindrical stator surrounds the circumference of the armature in the circumference direction. A brush holder is fixed to the stator, and the brushes are held in the brush holder to supply electric power.

The deceleration mechanism has the pinion gear 31, the middle gear 32, the output gear 33, the middle shaft 34, and the output shaft 35. The pinion gear 31 is fixed to the tip perimeter of the motor shaft 29 of the motor M. The middle gear 32 meshes with the pinion gear 31 to rotate. The output gear 33 meshes with the middle gear 32 to rotate. The middle shaft 34 is arranged to be parallel with the motor shaft 29. The output shaft 35 is arranged to be parallel to the motor shaft 29 and the middle shaft 34.

The output component transmits the driving force of the motor M to the valve object 1 through the valve shaft 2. The output component has the output gear 33 and the output shaft 35. The output gear 33 is rotated in response to the driving force of the motor M. The output shaft 35 is disposed at the rotation center of the output gear 33, and is connected to be able to rotate integrally with the output gear 33. The output gear 33 and the output shaft 35 correspond to a part of the deceleration mechanism, and the output shaft 35 corresponds to the output shaft of the deceleration mechanism.

The output component has the output lever 36, the pivot pin 37, and the follower 38. The output lever 36 is able to rotate integrally with the output shaft 35. The pivot pin 37 is held by the projection end of the output lever 36 at the eccentric position. The follower 38 is a ball bearing rotatably supported by the perimeter of the pivot pin 37. The output lever 36, the pivot pin 37, and the follower 38 correspond to a part of the conversion mechanism.

The output component has double ball bearings 41 and 42, and a cylinder collar 43. The double ball bearings 41 and 42 slidably support the output shaft 35 in the rotational direction. The cylinder collar 43 is press-fitted into the perimeter of the double ball bearings 41 and 42.

The output gear 33, the output shaft 35, the output lever 36, the pivot pin 37, the follower 38, the double ball bearings 41 and 42, and the cylinder collar 43, which constitute an output component, are assembled beforehand, and are attached to the housing 7 in the subassembly state. At this time, the pivot pin 37 and the follower 38 are inserted in the yoke slot 10 of the Scotch yoke 4. Here, the Scotch yoke 4, the output lever 36, the pivot pin 37, and the follower 38 also correspond to the conversion mechanism.

The EGR control valve has the return spring 6 which biases the valve shaft 2 to fully close the poppet valve. The return spring 6 is a coil-shaped compression spring which generates a biasing force (elastic power, restoring force) to bias the valve shaft 2 to close the poppet valve in the fully closing direction. The return spring 6 is arranged to spirally surround the circumference of the top side of the valve shaft 2 and the circumference of the bearing holder 28.

The return spring 6 has the coil part spirally wound between the spring seat 44 and the bottom 45 of the housing 7. The spring seat 44 is supported by a circular level difference adjacent to the upper end of the valve shaft 2. The bottom 45 of the housing 7 is a cylindrical recess on the perimeter side of the bearing holder 28. The perimeter part of the bearing holder 28 works as a guide part that guides the inner circumference of the coil part of the return spring 6.

The housing 7 integrally has the valve object 14 in which the poppet valve (the valve object 1, the valve shaft 2), the Scotch yoke 4, and the return spring 6 are arranged to be able to move. A part of the EGR passage is formed inside the valve object 14 in order of the inlet port 21, the passage hole 22-25 and the outlet port 26.

The valve object 14 further has the partition wall (partition part) 17 with the circular (cylindrical) shape, and the partition wall 17 defines a first passage and a second passage, as the EGR passage in the valve object 14. The first passage is located upstream side of the valve seat 18 in the flowing direction of EGR gas (exhaust gas). The first passage may be referred to a housing inlet side passage (the inlet port 21 and the passage hole 22). The second passage is located downstream side of the valve seat 18 in the flowing direction of EGR gas (exhaust gas). The second passage may be referred to a housing outlet side passage (the passage holes 24, 25 and the outlet port 26).

A circular circumferential slot is formed at the inner circumference portion of the partition 17 of the valve object 14 to surround the circumference of the valve seat 18 in the circumference direction. The perimeter of the circular valve seat 18 is press-fittingly fixed to the bottom surface (peripheral wall) of the circumferential slot. A circular valve seat is prepared in the seat edge of the valve seat 18, to which the valve object 1 can be seated on. The passage hole (valve hole of the EGR control valve, communication hole) 23 is defined inside of the valve seat 18, and EGR gas passes through the passage hole 23 that communicates the first passage (the inlet port 21, the passage hole 22) to the second passage (the passage holes 24, 25, the outlet port 26).

The cylindrical bearing holder 28 holding the perimeter of the metal bearing 27 is integrally formed in the valve object 14. The bearing holder 28 is arranged to surround the circumference of the metal bearing 27 in the circumference direction.

The joint flange 46 is formed at the lower end side (adjacent to the valve seat) of the valve object 14. The joint flange 46 has a joint end surface attached to an attachment component (fix component) of the EGR control valve, and is fixed to the clamp surface of the fix component using a tightening member such as bolt. Thereby, the EGR control valve is fixed to the fix component such as EGR pipe or intake pipe adjacent to the engine (on the vehicle side).

The housing 7 integrally has the motor case 15 that holds of the motor M. The motor case 15 has a based cylinder shape. A cylindrical side wall part of the motor case 15 surrounds the circumference of the motor yoke of the motor M in the circumference direction. An opening is defined in the motor case 15 at one end side of the side wall part, and the motor M is inserted through the opening at the time of attachment. The opening is closed by the front bracket 47 of the motor M. The front bracket 47 is fixed to the periphery of the opening of the motor case 15, using a fastening member such as bolt. Thereby, the motor M is accommodated in the motor case 15.

The gear case 16 for receiving the deceleration mechanism is formed in the housing 7. The gear case 16 integrally has the bearing holder 48 which holds the double ball bearings 41 and 42 and the cylinder collar 43 from the outer side. The bearing holder 48 is arranged to surround the double ball bearings 41 and 42 and the cylinder collar 43 in the circumference direction. The gear case 16 has an opening for inserting the electric actuator, and the opening is closed by the sensor cover 9 made of synthetic resin.

The sensor cover 9 has an internal connector and an external connector. The internal connector electrically connects the first and second brush terminals 49 projected from the front bracket 47 of the motor M to the first and second motor terminals (not shown). The external connector electrically connects the first and second motor terminals and plural sensor terminals of the rotation angle sensor 8 to an external circuit such as ECU 3 and battery.

The electric actuator has the motor M, the deceleration mechanism, the conversion mechanism, and the rotation angle sensing device. The motor M generates the driving force (torque) to reciprocate the poppet valve when receiving supply of electric power. The deceleration mechanism transmits the rotation of the motor shaft 29 of the motor M to the output shaft 35 by slowing down at two steps. The conversion mechanism converts the rotational movement of the output gear 33 of the deceleration mechanism into the linear (straight) reciprocating movement of the poppet valve in the axial direction. The rotation angle sensing device detects the degree of rotation angle of the output shaft 35.

The deceleration mechanism includes the pinion gear 31, the middle gear 32, the output gear 33, the middle shaft 34, and the output shaft 35.

The pinion gear 31 is fixed to the tip perimeter of the motor shaft 29 by press fitting. Plural pinion gear teeth 51 are formed around whole the perimeter of the pinion gear 31 to mesh with the middle gear 32 in the circumference direction.

The middle gear 32 is fitted to the perimeter of the middle shaft 34 so that relative rotation is possible. The middle gear 32 has a cylinder part that is rotatably inserted to the perimeter of the middle shaft 34 to rotate around the axial line of the middle shaft 34. The cylinder part has large diameter gear teeth 52 meshing with the pinion gear teeth 51 at the first axial end part, and small diameter gear teeth 53 meshing with the output gear 33 at the second axial end part.

The cylinder boss 54 is integrally formed in the inner circumference part of the output gear 33. The output gear 33 has a tooth formation part at the radially outer side of the cylinder boss 54 with a partially cylindrical shape (sector shape). The output gear teeth 55 meshing with the small diameter gear teeth 53 of the middle gear 32 is formed in the perimeter of the tooth formation part.

The output gear 33 integrally has a shaft combining portion 56 to close the opening of the cylinder boss 54 adjacent to the valve side. A through hole passes through the central part of the shaft combining portion 56 as a fitting hole which has a width of across flat (structure for preventing a skid of the output shaft 35). The input unit (the first projection axis part 57) of the output shaft 35 is fixed to the shaft combining portion 56 by fitting in the state where the skid is prohibited.

The first axial end of the middle shaft 34 is fixed by press-fitting to the fitting recess portion of the gear case 16 of the housing 7. The second axial end of the middle shaft 34 is fixed by press-fitting to the fitting recess portion of the sensor cover 9.

The output shaft 35 is rotatably and slidaly received inside of the bearing holder 48 of the housing 7 through the cylinder collar 43 and the double ball bearings 41 and 42. The output shaft 35 has the first projection axis part 57 and the second projection axis part 58 as the small diameter axis part at the respective sides in the axial direction. Moreover, the axial direction part is defined between the first projection axis part 57 and the second projection axis part 58, and is arranged in the bearing holder 48 of the housing 7. The axial direction part may be referred to an intermediate shaft part or a large diameter axis part having an outside diameter larger than that of the first and second projection axis parts 57 and 58. Each inner wheel of the double ball bearings 41 and 42 is held by the perimeter of the intermediate shaft part of the output shaft 35 by press fitting.

The conversion mechanism has the Scotch yoke 4, the output lever 36, the pivot pin 37, and the follower 38.

The Scotch yoke 4 has the first and second arms 11 and 12 extending to protrude toward the tip end from the base end, and the arm connector 13 which closes the opening between the first and second arms 11 and 12 adjacent to the base end.

The Scotch yoke 4 reciprocates in the axial direction of the valve shaft 2 in response to the driving force of the motor M transmitted through the follower 38 from the pivot pin 37. The Scotch yoke 4 is connected with the valve shaft 2 of the poppet valve so as to be integrally movable.

As shown in FIG. 1, in case where the poppet valve of the EGR control valve is fully closed (valve-closing time), when the poppet valve is biased in the fully closing direction, using only the biasing force of the return spring 6, a clearance S1 is defined between the follower 38 of the conversion mechanism and the inner surface (side surface of the yoke slot) of the first arm 11, and the follower 38 is in sliding contact with the inner surface (side surface of the yoke slot) of the second arm 12, in the Scotch yoke 4.

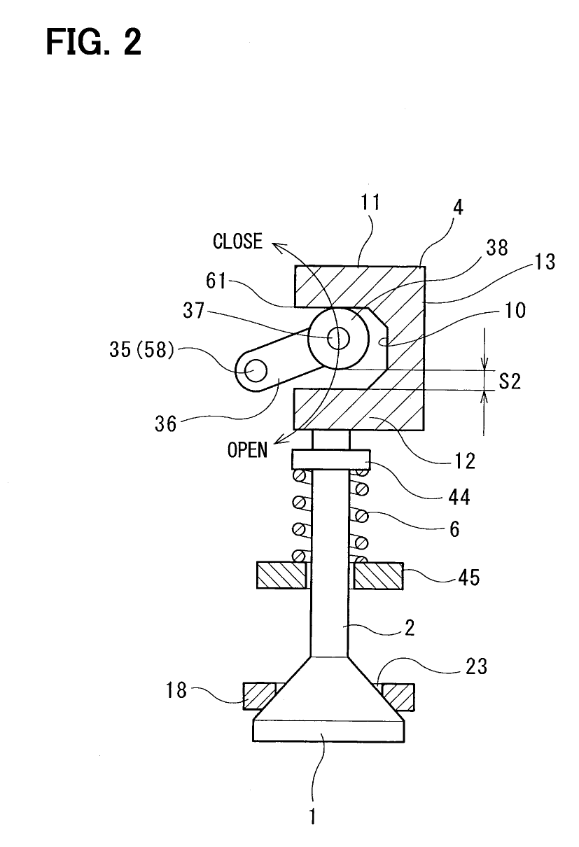

As shown in FIG. 2, in case where the poppet valve of the EGR control valve is fully closed (valve-closing time), when the poppet valve is biased in the fully closing direction, using both of the driving force of the motor M of the electric actuator and the biasing force of the return spring 6, the follower 38 is rotated in the valve closing direction and is slidingly in contact with the inner surface (side surface of the yoke slot) of the first arm 11, and a clearance S2 is formed between the follower 38 and the inner surface (side surface of the yoke slot) of the second arm 12, in the Scotch yoke 4.

As shown in FIG. 2, in case where the poppet valve of the EGR control valve is opened, when the poppet valve is operated to open using the driving force of the motor M of the electric actuator, the follower 38 is rotated in the valve open direction and is slidingly in contact with the inner surface (side surface of the yoke slot) of the second arm 12, in the Scotch yoke 4.

As shown in FIG. 2, in case where the poppet valve of the EGR control valve is closed, when the poppet valve is operated to close using the driving force of the motor M of the electric actuator, the follower 38 is rotated in the valve close direction and is slidingly in contact with the inner surface (side surface of the yoke slot) of the first arm 11, in the Scotch yoke 4.

The Scotch yoke 4 has the input unit and the output unit. The input unit has the U-shaped cross-section, and receives the driving force of the output component through the follower 38. The output unit transmits the driving force of the output component to the valve shaft 2.

The input unit of the Scotch yoke 4 has the polyhedron form (U-shaped cross-section or angled annular cross-section) with at least four surfaces (the first to fourth side surfaces in addition to the two surfaces opposing in the insertion direction in which the pivot pin 37 and the follower 38 are inserted at the time of attachment.

The input unit of the Scotch yoke 4 may have a ring-shaped cross-section to surround the circumference of the follower 38 in the circumference direction.

The yoke slot 10 defines the opening 61 through which the follower 38 is inserted into the yoke slot 10 by linearly moving the output component at the time of attachment relative to the Scotch yoke 4.

The output unit of the Scotch yoke 4 integrally has the fitting part 62 with the based round (or angled) cylindrical shape. The press fit slot 63 is defined inside of the fitting part 62, and the axial base end (input unit) of the valve shaft 2 is press-fitted to the press fit slot 63.

The output lever 36 is formed to project outward in the radial direction of the output shaft 35. The output lever 36 is a link lever which transmits the driving force of the motor M to the pivot pin 37 and the follower 38 by connecting the output shaft 35, the pivot pin 37, and the follower 38.

The first fitting hole is defined in the base end of the output lever 36. The second projection axis part 58 of the output shaft 35 is fitted to the first fitting hole by passing through the axial direction. Thereby, the output lever 36 is connected with the output shaft 35 so that integral rotation is possible.

The second fitting hole is defined in the tip part of the output lever 36. The pivot pin 37 is fitted to the second fitting hole by passing through in the axial direction. Thereby, the pivot pin 37 is connected with the output lever 36 so that integral rotation is possible. The second fitting hole is located at the position eccentric to the rotation center of the second projection axis part 58 of the output shaft 35 by a predetermined distance.

The pivot pin 37 is fixed to the output unit of the output lever 36 by fitting into the second fitting hole of the output lever 36. The pivot pin 37 supports the follower 38 in the rotatable state. Moreover, the pivot pin 37 is inserted into the yoke slot 10 of the Scotch yoke 4 with the follower 38.

The follower 38 is the ball bearing equipped with the inner wheel, the outer wheel and the plural steel balls. The inner wheel is fixed by pressing to the perimeter of the pivot pin 37. The outer wheel is slidingly in contact with the side surface of the yoke slot 10 of the Scotch yoke 4. The plural steel balls are slidingly received between the inner wheel and the outer wheel.

The follower 38 is rotatably supported by the perimeter of the pivot pin 37, and is inserted into the yoke slot 10 of the Scotch yoke 4. The follower 38 is located at the position eccentric to the rotation center of the second projection axis part 58 of the output shaft 35 by a predetermined distance. The follower 38 is connected with the output lever 36 through the pivot pin 37 in the integrally rotatable state.

The motor M which is the power source of the electric actuator is electrically connected to an external power supply (battery) of the vehicle through the motor drive circuit controlled by the ECU 3.

The ECU 3 includes a common microcomputer with CPU, memory (ROM, RAM, and EEPROM), an input circuit (input unit), an output circuit (output unit), a power supply circuit, and a timer circuit. The ECU 3 may correspond to a first valve position detector, a second valve position detector, a foreign object detector, a first memory, a second memory, and a foreign object remover.

The motor drive circuit is constituted by H bridged circuit in which a bridge connection is made among, for example, four semiconductor switching elements. The motor drive circuit is a drive circuit unit which drives the motor M based on a control signal, and variably controls the power supply (motor drive current or voltage) to the motor M in response to the control signal (such as duty ratio of a PWM signal) given from the microcomputer of ECU 3.

The control signal given to the motor drive circuit represents a ratio of ON/OFF in a manner that an actual valve lifting amount (actual opening degree or actual EGR rate) corresponds to a target valve lifting amount (target opening degree or target EGR rate). The generating cycle (PWM cycle) of the PWM (pulse width modulation) signal is constructed by the ON period in which electricity is supplied to the internal conductor (such as armature coil) of the motor M and the OFF period in which the energizing of the internal conductor (such as motor winding part, for example, an armature coil) of the motor M is stopped.

The CPU performs various numerical operation processing, information processing, control, etc. by a program. The program needed for the numerical operation processing, information processing, control, etc. performed in the CPU is memorized beforehand in the ROM. The RAM temporarily records the middle information in the operation processing by the CPU, and the stored information is deleted when an ignition switch (engine switch) is turned off. Information required for various numerical operation processing, information processing, control, etc. by the CPU is memorized in the EEPROM. The EEPROM may correspond to a first memory and a second memory.

The sensor output signal (analog voltage) from the rotation angle sensor 8 installed in the sensor loading part of the sensor cover 9 and the sensor output signal (electric signal) from various sensors are ND converted by the ND conversion circuit, and inputted into the input unit of the microcomputer. The input unit of the microcomputer is connected with not only the rotation angle sensor 8 but an air flow meter 71, a crank angle sensor 72, an accelerator sensor 73, a throttle sensor 74, an intake temperature sensor 75, a water temperature sensor 76, and a discharge gas sensor (such as air/fuel ratio sensor, oxygen concentration sensor: not shown).

The rotation angle sensing device has a cylindrical magnetic circuit unit and the rotation angle sensor 8. The magnetic circuit unit is integrally rotatably provided to the cylinder boss 54 of the output gear 33. The rotation angle sensor 8 measures the rotation angle of the magnetic circuit unit to detect the valve opening of the EGR control valve. The rotation angle sensing device detects a variation in the relative rotation angle between the magnetic circuit unit and the rotation angle sensor 8 based on a magnetic change provided to the rotation angle sensor 8 from the magnetic circuit unit.

The rotation angle sensor 8 has a Hall IC which outputs a sensor output signal (analog-voltage signal, sensor output voltage) to the ECU 3. The sensor output signal corresponds to the magnetic flux density which intersects the magnetic sensing surface of the semiconductor Hall element. The Hall IC may be replaced with a non-contact type magnetic detection element such as simple Hall device or magnetoresistive element.

The magnetic circuit unit has a pair of partially-cylindrical yokes 81 that is defined by dividing into two in the radial direction of the cylinder boss 54 and a pair of magnets (permanent magnet) 82. The pair of magnets 82 are arranged in a manner that a magnetic pole is defined to oppose in the same direction as the division part (opposing part) of the yoke 81.

The magnetic circuit unit is fixed to the inner circumference of the cylinder boss 54 by, for example, adhesives. In case where the cylinder boss 54 is made of synthetic resin, the magnetic circuit unit may be produced by insert molding relative to the cylinder boss 54.

The ECU 3 corresponds to a stroke amount (or flow rate) detector detecting the stroke amount of the poppet valve (valve lift or flow rate) based on the sensor output signal (sensor voltage) outputted from the rotation angle sensor 8. Moreover, the ECU 3 corresponds to a lever angle detector detecting the rotation angle of the output lever 36 (lever rotation angle) based on the sensor output signal (sensor voltage) outputted from the rotation angle sensor 8.

The crank angle sensor 72 has a pickup coil which converts the rotation angle of an engine crankshaft into an electric signal, and outputs a sensor output signal (henceforth, NE pulse signal) to the ECU 3 every predetermined crank angle such as 15° C.A or 30° C.A.

The ECU 3 corresponds to a revolving speed detector detecting the engine revolving speed (engine rotation number: NE) by measuring the interval time between the NE pulse signals outputted from the crank angle sensor 72.

The accelerator sensor 73 corresponds to an engine load detector that outputs an electric signal (sensor output signal) corresponding to the pressing amount of the accelerator (accelerator opening: ACCP) to the ECU 3. The throttle sensor 74 may be also used as an engine load detector.

The intake temperature sensor 75 is an intake air temperature detector that outputs an electric signal (sensor output signal) to the ECU 3, which corresponds to the temperature of intake air (intake air temperature: THA) drawn to the engine cylinder.

The water temperature sensor 76 is a water temperature detector that outputs an electric signal (sensor output signal) corresponding to the temperature of the engine-cooling-water (water temperature: THW) to the ECU 3. When the ignition switch is turned on (IG-ON), the ECU 3 acquires (inputs) various sensor output signals to calculate the engine operation situation (engine information) or the operating condition (state). Based on the engine operation situation or the operating condition and the program stored in the ROM, the ECU 3 electronically controls the driving force of the motor M of the electric actuator.

The ECU 3 obtains the amount of fresh air measured from the engine operation situation, for example, the sensor output signal (intake air flow signal) outputted from the air flow meter 71, and calculates (determines) a target value (target opening) corresponding to the engine speed (NE) measured from the NE signal of the crank angle sensor 72. Feedback control of the control signal provided to the motor drive circuit is performed to reduce the deviation between the actual opening (the actual valve position or the actual EGR rate) measured from the sensor output voltage of the rotation angle sensor 8 and the target opening (the target valve position or the target EGR rate) using well-known PID control. For example, the duty ratio of the PWM signal is set as drive DUTY value (Duty=±α%)). That is, the drive DUTY value applied to the motor drive circuit is variably controlled based on the deviation between the actual opening and the target opening, such that the torque (driving force, drive torque) generated by the motor M is controlled in the motor rotational direction and the motor revolving speed.

When the ECU 3 provides the preset drive DUTY value (Duty=+α%) to the motor drive circuit to generate the driving force (open side motor torque) of the motor M to open the valve object 1 of the poppet valve against the biasing force (spring force) of the return spring 6, electric power corresponding to Duty=+α% is supplied to the internal conductor (armature coil) of the motor M, and the motor drive current flows through the armature coil of the motor M in the valve open direction (to open the valve object 1). Thereby, the poppet valve (the valve object 1, the valve shaft 2) is driven to open against the biasing force of the return spring 6. When the drive DUTY value is changed from the minimum (Duty=+0%) to the maximum (Duty=+100%), the valve object 1 of the poppet valve is controlled from the fully close position to the fully open position.

When the ECU 3 provides the preset drive DUTY value (Duty=−α%) to the motor drive circuit to generate the driving force (close side motor torque) of the motor M to close the valve object 1 of the poppet valve so as to assist the biasing force of the return spring 6, electric power corresponding to Duty=−α% is supplied to the internal conductor (armature coil) of the motor M, and the motor drive current flows through the armature coil of the motor M in the valve close direction (to close the valve object 1). Thereby, the valve object 1 and the valve shaft 2 are driven to close to assist the biasing force of the return spring 6.

### (Control Method)

A method of detecting, deforming and removing a foreign object by the ECU 3 is briefly explained based on FIG. 1 to FIG. 10.

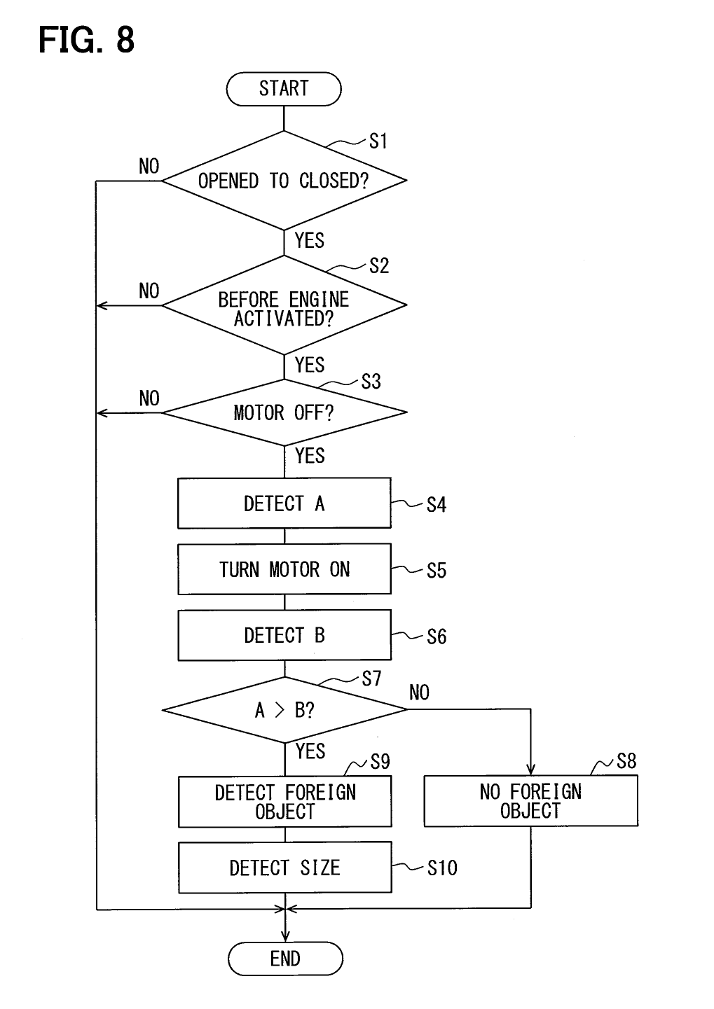

FIG. 8 is a flow chart explaining the foreign object detection method by the ECU 3. After the ignition switch is turned off (IG-OFF), the control routine of FIG. 8 is started when the door (driver side door) of the vehicle is opened.

The ECU 3 determines whether the door of the vehicle is changed from the opened state to the closed state (S1). When the determination result of S1 is NO, the control routine of FIG. 8 is ended. The determination at S1 may be performed based on a detection of seating detection switch that is ON when the driver is seated on the driver seat, or based on the unlock of the driver side door from the exterior of the vehicle.

When the determination result of S1 is YES, it is determined whether it is before the engine starting (S2). When the determination result of S2 is NO, the control routine of FIG. 8 is ended.

When the determination result of S2 is YES, it is determined whether the motor M of the electric actuator is OFF (S3). When the determination result of S3 is NO, the control routine of FIG. 8 is ended.

When the determination result of S3 is YES, as shown in FIG. 1, the poppet valve is biased to close using only the biasing force of the return spring 6 so that the valve object 1 of the poppet valve is pressed against the valve seat 18. At this time, the clearance S1 is formed between the slot side surface of the first arm 11 of the Scotch yoke 4 and the follower 38, and the follower 38 is in contact with the slot side surface of the second arm 12 of the Scotch yoke 4.

In this state, the sensor output voltage of the rotation angle sensor 8 is acquired by the sensor output signal acquisition portion. The first valve position (the first valve lifting amount, the first valve stroke amount: A) is detected from the sensor output voltage by the first valve position detector. At S4, the first valve position (A) is recorded on the EEPROM (first memory).

Next, the motor M of the electric actuator is turned on (S5). Electric power supplied to the motor M is controlled to use the driving force of the motor M larger than the biasing force of the return spring 6, the poppet valve is driven to close so that the valve object 1 is pressed against the valve seat 18. At this time, the follower 38 is in contact with the slot side surface of the first arm 11 of the Scotch yoke 4, and a clearance (S2) is formed between the slot side surface of the second arm 12 of the Scotch yoke 4 and the follower 38.

In this state, the sensor output voltage of the rotation angle sensor 8 is acquired by the sensor output signal acquisition portion. The second valve position (the second valve lifting amount, the second valve stroke amount: B) is detected from the sensor output voltage by the second valve position detector. At S6, the second valve position (B) is recorded on the EEPROM (second memory).

Next, the first valve position (A) stored in EEPROM is compared with the second valve position (B) stored in EEPROM. Specifically, it is determined whether the first valve position (A) is located on the valve-open side than the second valve position (B) at S7. When the determination result of S7 is NO, it is determined that there is no foreign object D between the valve object 1 and the valve seat 18 at S8, and the control routine of FIG. 8 is ended.

When the determination result of S7 is YES, it is determined that there is a foreign object D between the valve object 1 and the valve seat 18, since the first valve position (A) is located on the valve-open side from the second valve position (B), and a detection flag of foreign object (FLAG1=ON) is set and record on EEPROM at S9.

The difference between the first valve position (A) and the second valve position (B) is calculated to detect the size of the foreign object D, and the size detection flag (FLAG2=ON) of foreign object is set and record on EEPROM at S10, and the control routine of FIG. 8 is ended.

The control processing of S7-S10 may correspond to a foreign object detector. Namely, based on the comparison result between the first valve position (A) and the second valve position (B), the existence of foreign object D between the valve object 1 and the valve seat 18, and the size of foreign object D is detected by the foreign object detector.

In case of FLAG1=ON or FLAG2=ON, the ECU 3 repeatedly detects the first valve position (A) for every starting of the control routine of FIG. 8. When the first valve position (A) is detected, the first valve position (A) is updated and recorded as a present valve position (An) on EEPROM. Further, the valve position before the update is recorded as a last time valve position (An−1) by the EEPROM (first memory).

In case of FLAG1=ON or FLAG2=ON, the ECU 3 repeatedly detects the second valve position (B) for every starting of the control routine of FIG. 8. When the second valve position (B) is detected, the second valve position (B) is updated and recorded as a present valve position (Bn) on EEPROM. Further, the valve position before the update is recorded as a last time valve position (Bn−1) by the EEPROM (second memory).

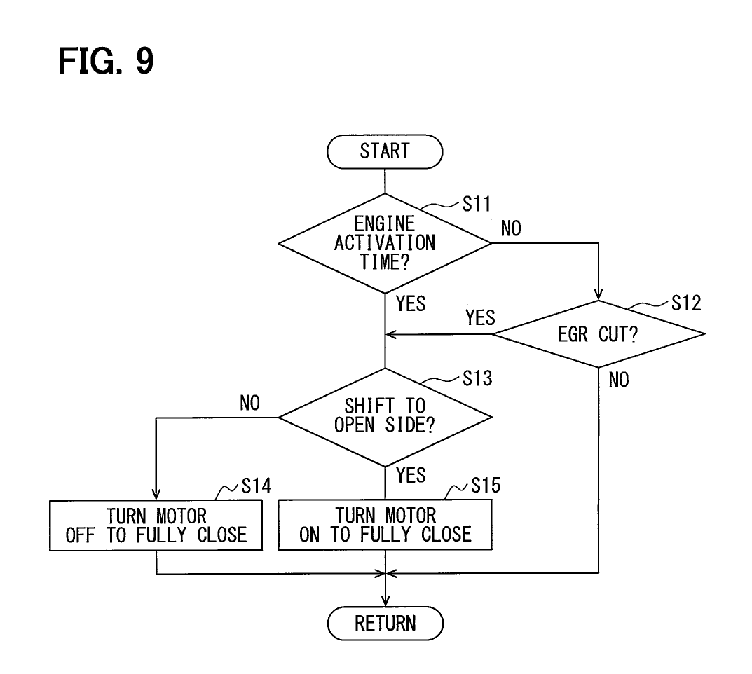

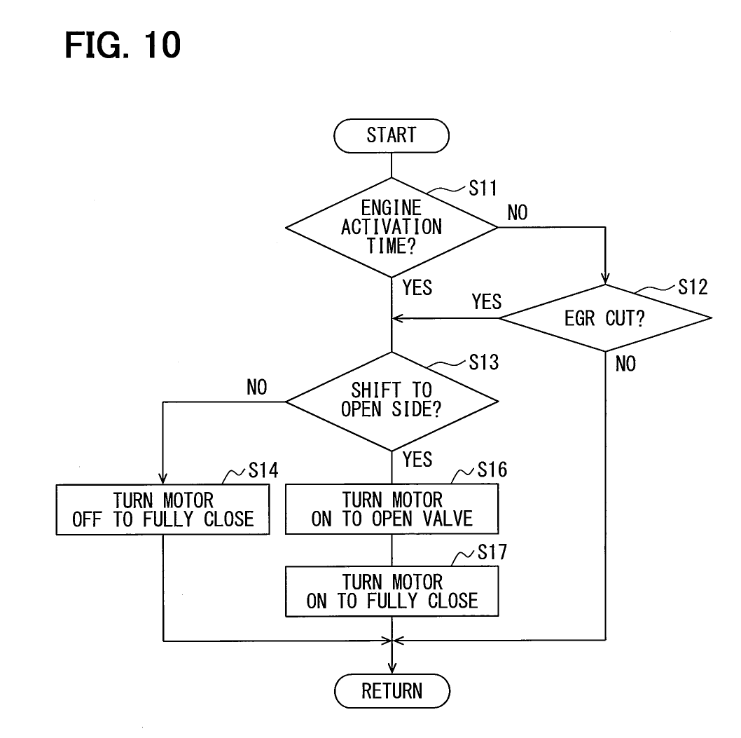

FIG. 9 and FIG. 10 are flow charts explaining the foreign object deforming and removing process by the ECU 3. The control routine of FIG. 9 and FIG. 10 is repeatedly performed with a predetermined cycle, after the ignition switch is turned on (IG-ON).

At a timing at which the control routine of FIG. 9 starts, it is determined whether it is an engine activation timing (S11). When the determination result of S11 is NO, it is determined whether it is under EGR cut (S12). When the determination result of S12 is NO, the control routine of FIG. 9 is ended.

The EGR cut is performed, for example, at idling operation where the engine load is low and the engine rotation speed is low, in order to stabilize the engine combustion by stopping the introduction of EGR gas to the combustion chamber of each engine cylinder. Moreover, when a driver presses down the accelerator pedal to accelerate, e.g., maximize the engine output, the introduction of EGR gas to the combustion chamber of each engine cylinder is stopped in order to avoid lowering in the engine output as the EGR cut.

The present valve position (An) and the last time valve position (An−1) are taken out from EEPROM, and are compared with each other, thereby determining whether the present valve position (An) is shifted to the valve-open side than the last time valve position (An−1) at S13. The present valve position (Bn) and the last time valve position (Bn−1) are taken out from EEPROM, and are compared with each other, thereby determining whether the valve position (Bn) is shifted to the valve-open side than the last time valve position (Bn−1) at S13.

When the determination result of S13 is NO, the motor M of the electric actuator is turned off, and the valve object 1 of the poppet valve is pressed against the valve seat 18 using only the biasing force of the return spring 6 so as to bias the poppet valve (the valve object 1, the valve shaft 2) in the closing direction to fully close the valve at S14. Then, the control routine of FIG. 9 is ended.

When the determination result of S13 is YES, the motor M of the electric actuator is turned on to use the driving force of the motor M that is larger than the biasing force of the return spring 6, so as to fully close the poppet valve (the valve object 1, the valve shaft 2) by pressing the valve object 1 against the valve seat 18 at S15. Then, the control routine of FIG. 9 is ended.

The control processing of S13-S15 may correspond to a foreign object remover. The first foreign object remover drives the poppet valve (the valve object 1, the valve shaft 2) to the closing side by pressing the valve object 1 against the valve seat 18 using the driving force of the motor M by energizing the motor M when the present valve position (An−1) is determined to be shifted on the valve-open side than the last time valve position (An−1) by taking out from EEPROM and comparing the present valve position (An) and the last time valve position (An−1).

Moreover, the second foreign object remover may drive the poppet valve (the valve object 1, the valve shaft 2) to the closing side by pressing the valve object 1 against the valve seat 18 using the driving force of the motor M by energizing the motor M when the present valve position (Bn−1) is determined to be shifted on the valve-open side than the last time valve position (Bn−1) by taking out from EEPROM and comparing the present valve position (Bn) and the last time valve position (Bn−1).

Similarly to the control routine of FIG. 9, S11-S14 are performed when it becomes a timing at which the control routine of FIG. 10 starts.

When the determination result of S13 is YES, the motor M of the electric actuator is turned on and the valve object 1 of the poppet valve is once operated to the valve open side using the driving force of the motor M at S16. Next, at S17, the poppet valve (the valve object 1, the valve shaft 2) is driven to the closing side to be fully closed by using the driving force of the motor M that is larger than the biasing force of the return spring 6, by energizing the motor M of the electric actuator so that the valve object 1 is pressed against the valve seat 18. Then, the control routine of FIG. 10 is ended.

The control processing of S13, S14, S16, and S17 may correspond to a foreign object remover. Namely, when the present valve position (An−1) is shifted to the valve-open side than the last time valve position (An−1), the motor M is energized to open the valve object 1 once on the valve open side by a predetermined valve opening (valve lift, valve stroke) using the driving force of the motor M. Then, again immediately after the valve is operated to open, the motor M is energized to close the poppet valve (the valve object 1, the valve shaft 2) so that the valve object 1 is pressed against the valve seat 18 using the driving force of the motor M by the first foreign object remover.

Moreover, when the present valve position (Bn−1) is shifted to the valve-open side than the last time valve position (Bn−1), the motor M is energized to open the valve object 1 once on the valve open side by a predetermined valve opening (valve lift, valve stroke) using the driving force of the motor M. Then, again immediately after the valve is operated to open, the motor M is energized to close the poppet valve (the valve object 1, the valve shaft 2) so that the valve object 1 is pressed against the valve seat 18 using the driving force of the motor M by the second foreign object remover.

According to the first embodiment, before the engine is started, the ECU 3 detects the first valve position and detects the second valve position. Further, during engine operation, if a foreign object D is located between the valve object 1 and the valve seat 18, the (first, second) foreign object remover can deform the foreign object D to reduce the leak flow of EGR gas or can remove the foreign object D.

Since the clearance between the valve object 1 and the valve seat 18 can be made small, the valve object 1 can be set at the fully closed position (where the valve object 1 is seated on the valve seat 18) when the poppet valve of the EGR control valve is fully closed. Thereby, since the increase in the leak flow of EGR gas can be controlled when the EGR control valve is fully closed, the engine output power and the exhaust emission can be suppressed from deteriorating.

The ECU 3 has the first memory, the second memory and the (first and second) foreign object remover. When a foreign object D intervenes between the valve object 1 and the valve seat 18, the foreign object D can be deformed and removed. When the EGR control valve is fully closed, it is possible to bring the valve object 1 close to the fully closed position (where the valve object 1 is seated on the valve seat 18), and the increase in the leak flow of EGR gas can be controlled.

Furthermore, because the first valve position detector can detect the first valve position (A), abnormality in the valve return function of the return spring 6 can also be detected. Moreover, because the second valve position detector can detect the second valve position (B), abnormality in the valve return function of the return spring 6 can also be detected.

The ECU 3 activates the first valve position detector, the second valve position detector, and the foreign object detector before the engine is started or in response to opening, closing or locking of a door of the vehicle having the engine. Therefore, at the time of engine starting, the engine control can be performed in accordance with the leak flow of EGR gas when the valve is fully closed.

Moreover, since the clearance between the valve object 1 and the valve seat 18 can be made small when the EGR control valve is fully closed, the increase in the leak flow of EGR gas can be controlled when the EGR control valve is fully closed. Therefore, the EGR rate, that is a ratio of EGR gas flow rate to the total flow rate of intake air supplied to the combustion chamber of each engine cylinder, can be restricted from becoming too much high. Thus, the oxygen concentration in the intake air does not fall. Accordingly, fault such as engine stalling can be restricted.

### Second Embodiment

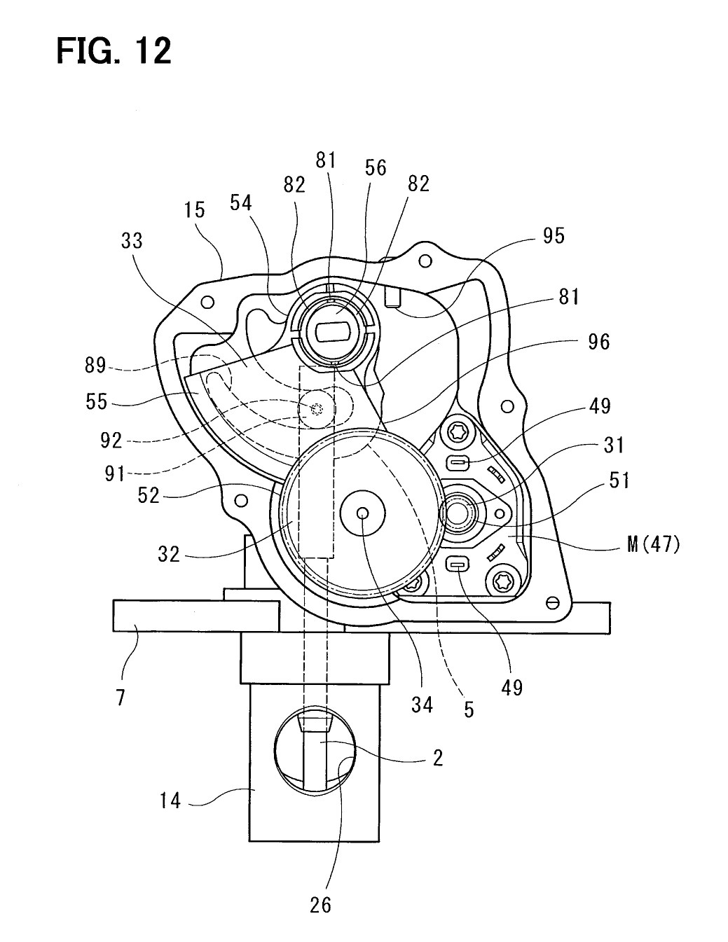

FIG. 11 and FIG. 12 illustrate an EGR control valve of the second embodiment for an EGR system.

The EGR control valve has the electric actuator with the motor M which generates the driving force to drive the poppet valve (the valve object 1, the valve shaft 2). The deceleration mechanism slows down the rotation of the motor M and transmits the rotation to the output shaft 35. The return spring 6 biases the valve shaft 2 to press the valve object 1 against the valve seat 18 to close the valve. The housing 7 receives the electric actuator inside, and the ECU 3 electronically controls the motor drive circuit so as to control the position of the poppet valve (the valve object 1, the valve shaft 2).

The rotation angle sensor 8 is attached to the sensor cover 9 that closes the opening of the recess, that receives the actuator, of the housing 7 of the EGR control valve. The rotation angle sensor 8 outputs the voltage signal corresponding to the rotation angle of the plate cam 5 of the conversion mechanism to be mentioned later.

The EGR control valve further has the conversion mechanism between the output shaft 35 which is an output shaft of the electric actuator and the valve shaft 2. The conversion mechanism converts the rotational movement of the output shaft 35 into the linear (straight) reciprocating movement of the valve shaft 2.

The conversion mechanism has the plate cam 5, the follower 91, and the pivot pin 92. The plate cam 5 is able to rotate integrally with the output shaft 35. The follower 91 is movably inserted into the cam slot (cam groove) 89 of the plate cam 5. The pivot pin 92 drives the valve shaft 2 to reciprocate in the axial direction in response to receiving the driving force of the motor M through the follower 91 from the plate cam 5.

When the poppet valve is located at the fully closed position, the rotational position (cam angle) of the plate cam 5 is set to be in the fully closed state at the cam fully closed position. When the poppet valve is located at the fully open position, the rotational position (cam angle) of the plate cam 5 is set to be in the fully open state at the cam fully open position.

The plate cam 5 has the circular input unit which surrounds the middle diameter part of the output shaft 35 in the circumference direction. A square-shaped fitting hole passes through the input unit, and the plate cam 5 is fixed to the middle diameter part of the output shaft 35 in the rotation-stopped state. The input unit of the plate cam 5 is fixed to the middle diameter part of the output shaft 35 by separating from the output gear 33 by a predetermined distance in the axial direction in the state where the input unit of the plate cam 5 is interposed between the annular surface of the step (level difference) part of the output shaft 35 and the annular end surface of the metal collar 93.

The plate cam 5 has the sector-shaped output unit that partially surrounds the circumference of the input unit. The output unit has the cam slot 89 passing through the plate cam 5 in the thickness direction. The cam slot 89 has the curved shape corresponding to the operation pattern of the poppet valve (the lift amount of the poppet valve relative to the rotation angle (cam angle) of the plate cam 5).

The plate cam 5 or the interlocking component engaged to be integrally rotatable with the plate cam 5 (such as the output gear 33, the output shaft 35, or the output gear lever 94) integrally has the full-open stopper part 96. The full-open stopper part 96 is engaged with the full open stopper 95.

Insert molding is carried out in the state where the output gear lever 94 is arranged inside the output gear 33 made of synthetic resin. The output gear lever 94 has the fitting hole with the width of across flat (rotation stop structure for preventing a skid of the output shaft 35) inside. Thereby, the output gear 33 is fixed to the small diameter part of the output shaft 35 through the output gear lever 94 in the state where the rotation is stopped.

The full open stopper 95 is fixed to be projected in the recess portion from the end surface of the outer wall part of the gear case 16 of the housing 7 by thrusting the axial part. The outer wall part is a cylindrical peripheral wall part which surrounds the circumference of the recess portion that receives the electric actuator in the circumferential direction. The full open stopper 95 works as not only a stopper at the full open position of the plate cam 5 but as a stopper at the valve full open position that defines the full open position (the full lift amount) of the poppet valve.

Accordingly, the second embodiment achieves the same effect and advantage as the first embodiment.

### Other Embodiment

The present disclosure may be applied to a waste gate valve, a scroll passage switch valve, an exhaust flow control valve, an exhaust pressure control valve, an exhaust switch valve, or an exhaust throttle valve.

The poppet valve may be replaced with other rotation-type valve such as butterfly valve, flap valve, plate valve, or rotary valve by placing a conversion mechanism between a valve and a shaft.

The poppet valve may be integrally constructed by the valve object 1 and the valve shaft 2. The poppet valve may be replaced with a double poppet valve. An operation rod extending in the axial direction may be used instead of the valve shaft 2. The internal combustion engine may be multi-cylinder diesel engine or multi-cylinder gasoline engine which has plural cylinders, or single cylinder engine.

Such changes and modifications are to be understood as being within the scope of the present disclosure as defined by the appended claims.

What is claimed is:

1. An exhaust device for an internal combustion engine comprising:
a valve seat in which a passage is defined to pass through from a cylinder of the internal combustion engine;
a valve unit having
a valve object seated on or separated from the valve seat to open or close the passage, and
a valve shaft that supports the valve object, the valve shaft extending in an axial direction, the valve unit being able to move in the axial direction;
a motor that generates a driving force to drive the valve unit;
a rotation shaft rotated in response to the driving force of the motor;
a conversion mechanism that converts a rotational movement of the rotation shaft to a linear movement of the valve unit;
an actuator that drives the valve object to open or close by transmitting the driving force of the motor to the valve unit through the rotation shaft and the conversion mechanism;
a spring that generates a biasing force to bias the valve unit to close the passage;
a sensor that outputs a signal corresponding to a current position of the valve unit; and
a control device controlling the motor based on an output signal of the sensor, wherein the control device has
a first valve position detector detecting a first valve position from the output signal of the sensor when the valve unit is biased to close using only the biasing force of the spring to press the valve object against the valve seat,
a second valve position detector detecting a second valve position from the output signal of the sensor when the valve unit is biased to close using the driving force of the motor that is larger than the biasing force of the spring by supplying electricity to the motor to press the valve object against the valve seat, and
a foreign object detector that detects a foreign object between the valve object and the valve seat by comparing the first valve position and the second valve position with each other and that detects a size of the foreign object based on a comparison result between the first valve position and the second valve position.

2. The exhaust device according to claim 1, wherein
the first valve position detector repeatedly detects the first valve position, and
the first valve position detector has a first memory that updates and records the first valve position as a present position when detecting the first valve position, and that updates and records a previous present position as a last time position.

3. The exhaust device according to claim 2, wherein
the control device takes out the present position and the last time position from the first memory, and compares the present position and the last time position with each other, and
the control device has a foreign object remover that drives the motor to close the valve unit by pressing the valve object against the valve seat using the driving force of the motor when the present position is shifted to a valve-open side than the last time position.

4. The exhaust device according to claim 2, wherein
the control device takes out the present position and the last time position from the first memory, and compares the present position and the last time position with each other, and
the control device has a foreign object remover that drives the motor to once open the valve unit and then close the valve unit by pressing the valve object against the valve seat using the driving force of the motor when the present position is shifted to a valve-open side than the last time position.

5. The exhaust device according to claim 1, wherein
the second valve position detector repeatedly detects the second valve position, and
the second valve position detector has a second memory that updates and records the second valve position as a present position when detecting the second valve position, and that updates and records a previous present position as a last time position.

6. The exhaust device according to claim 5, wherein
the control device takes out the present position and the last time position from the second memory, and compares the present position and the last time position with each other, and
the control device has a foreign object remover that drives the motor to close the valve unit by pressing the valve object against the valve seat using the driving force of the motor when the present position is shifted to a valve-open side than the last time position.

7. The exhaust device according to claim 5, wherein
the control device takes out the present position and the last time position from the second memory, and compares the present position and the last time position with each other, and
the control device has a foreign object remover that drives the motor to once open the valve unit and then close the valve unit by pressing the valve object against the valve seat using the driving force of the motor when the present position is shifted to a valve-open side than the last time position.

8. The exhaust device according to claim 1, wherein
the control device controls the first valve position detector, the second valve position detector, and the foreign object detector to activate before the internal combustion engine is activated or when a door of a vehicle to which the internal combustion engine is mounted is opened, closed or locked.

9. The exhaust device according to claim 1, wherein
the conversion mechanism has
a lever projected outward in a radial direction of the rotation shaft, the lever being integrally rotatable with the rotation shaft,
an eccentric pin held by the lever,
a follower rotatably supported by the eccentric pin, and
a yoke that receives the driving force of the motor from the eccentric pin through the follower to reciprocate in the axial direction of the valve shaft, the yoke being integrally rotatable with the valve shaft, and
the lever holds the eccentric pin at a position eccentric to a rotation center of the rotation shaft.

10. The exhaust device according to claim 9, wherein
the yoke has a yoke slot into which the follower is able to be inserted, and
the follower is rotatably supported by the eccentric pin, and is slidably inserted into the yoke slot.

11. The exhaust device according to claim 9, wherein
the sensor outputs a signal corresponding to a rotation angle of the lever to the control device.

12. The exhaust device according to claim 1, wherein
the conversion mechanism has a cam integrally rotatable with the rotation shaft, and
the cam has a cam slot shaped to correspond to an operation pattern of the valve unit.

13. The exhaust device according to claim 12, wherein
the conversion mechanism further has
a follower movably inserted to the cam slot, and
a pivot receiving the driving force of the motor from the cam through the follower to drive the valve shaft in the axial direction.

14. The exhaust device according to claim 12, wherein
the sensor outputs a signal corresponding to a rotation angle of the cam to the control device.
